(19) United States
(12) Patent Application Publication
(10) Pub. No.: US 2026/0210897 A1
(43) Pub. Date: Jul. 23, 2026

(54) MEASUREMENT DEVICE FOR DETERMINING A CONSTITUENT OF A FLUID SAMPLE

(71) Applicant: ProMinent GmbH, Heidelberg (DE)

(72) Inventors: Dominik DANTRIMONT, Edingen-Neckarhausen (DE); Thomas KÄFER, Abtsteinach (DE); Marcel KRUG, Eppelheim (DE); Holger SCHOPF, Heilbronn (DE); Klaus KOPPERT, Mannheim (DE)

(21) Appl. No.: 19/457,451

(22) Filed: Jan. 23, 2026

(30) Foreign Application Priority Data
Jan. 23, 2025 (DE) 10 2025 102 459.6

(51) Int. Cl. G01N 27/27; G01N 1/14; G01N 27/416

(52) U.S. Cl. CPC G01N 27/27; G01N 1/14; G01N 27/4163; G01N 27/4165; G01N 27/4167; G01N 27/4168

(57) ABSTRACT

The invention relates to a measuring device for determining a constituent of a fluid sample, as well as to a method for determining a constituent of a fluid sample using this measuring device.

### CROSS-REFERENCE TO RELATED APPLICATION

This application claims the benefit of German Application No. 10 2025 102 459.6, filed Jan. 23, 2025, the disclosure of which is incorporated by reference herein in its entirety.

### FIELD OF THE INVENTION

The invention relates to a measuring device for determining a constituent of a fluid sample, as well as to a method for determining a constituent of a fluid sample using this measuring device.

### BACKGROUND OF THE INVENTION

The present invention relates to a measuring device for determining a constituent of a fluid sample, in particular a measuring device for determining oxidizing agents, such as chlorine, in fluid media, for example in aqueous samples. Oxidizing agents are used in a multitude of applications, for example for disinfection in water treatment, in processes in chemical plants, or to ensure hygiene in industrial and municipal systems. In many cases, their concentration not only needs to be monitored precisely, but also regulated or completely excluded in order to ensure the desired functionality and safety of the systems.

An example of the use of systems for monitoring the absence of oxidizing agents, which are capable of determining trace amounts of a substance in a fluid sample, is the monitoring of activated carbon filters in water treatment. Activated carbon filters are frequently used to remove free chlorine, chloramines, or other oxidizing agents from water before it enters downstream processes such as reverse osmosis plants or production systems. Chlorine is a strong oxidizing agent and can damage sensitive membranes or materials in these systems.

Measuring devices for real-time monitoring are therefore used in order to detect “breakthroughs” and subsequently inhibit oxidizing agents, such as chlorine, from entering downstream process steps. Such measuring devices alert the user in the event that trace amounts of chlorine are present in the fluid sample.

While monitoring the presence of larger quantities of oxidizing agents is possible in a relatively straightforward manner using a variety of commercially available sensors, the detection of trace amounts or their complete absence presents a particular challenge. Conventional sensors detect certain chemical or physical measurement properties that correlate with the presence of an oxidizing agent. However, once no oxidizing agent is present over a certain period, many of these sensors provide unreliable or inaccurate values. This leads to increased uncertainty in critical applications where precise verification of the absence of oxidizing agents is essential, and residue-free or contamination-free conditions are required.

Redox potential sensors or amperometric sensors are typically used for the detection of trace amounts. Redox potential sensors exhibit a change in signal even at trace concentrations of free chlorine. Although, in principle, there is a correlation between redox potential and chlorine concentration according to the Nernst equation, the chlorine concentration cannot be directly calculated from the redox potential in practice. Furthermore, such sensors tend to become blinded, meaning they show reduced sensitivity or increased inertia with respect to changes in concentration. This impairment of function is triggered by physical, chemical, or biological processes at the electrode surface. After prolonged absence of the oxidizing agent, amperometric sensors tend to exhibit zero point drift, i.e., changes in the signal transmitted by the sensor when no oxidizing agent is present. In addition, physical, chemical, or process-related influences can affect the zero point of the sensor. If breakthrough detection is performed using a purely static criterion, even a slight upward shift of the zero point can lead to the detection threshold being exceeded, resulting in false alarms. Conversely, if the zero point shifts downward, the detection threshold is unintentionally increased. As a result, reliable trace detection cannot be ensured.

It is assumed that the effects mentioned above may, under certain circumstances, be attributable to changes in the active electrode surface over time. Restoring sensitivity and measurement accuracy requires increased maintenance effort and can only be performed by qualified personnel. In such cases, the working electrode of the sensor typically needs to be reconditioned until the active electrode surface is restored and meaningful measurement values can once again be obtained.

The commercially available measuring device W&T/Siemens Deox/2000® addresses part of the aforementioned problems by continuously supplying a conditioning agent from the outside into the measuring chamber and converting it at the working electrode. This keeps the electrode permanently in a condition suitable for measurement. The conditioning agent, I₂, is produced in a reaction tube upstream of the measuring chamber by the redox reaction of KI with KIO₃ in the presence of acetic acid. The aqueous I₂ solution is then introduced into the measuring chamber by means of a peristaltic pump. For the determination of the concentration of a constituent in a sample, a defined amount of sample is mixed into the I₂ solution before it is supplied to the measuring chamber. By reaction of the iodide with the oxidizing or of the iodine with the reducing constituent of the sample, the concentration of iodine is increased or decreased. This also alters the measurement value of the amperometric sensor, which allows the concentration of the constituent to be determined.

However, this method not only requires the integration of a reaction tube into the measuring device but also necessitates the provision and continuous dosing of appropriate quantities of chemicals for ongoing operation. The constant consumption of chemicals results in high operating costs and additionally places a burden on wastewater.

In addition to the issues mentioned above, the measurement values of current systems are highly dependent on external influences that are not directly related to the oxidizing agent to be detected itself.

### OBJECTIVE OF THE INVENTION

Embodiments of the present invention provide a measuring device that solves the aforementioned problems and, in particular, exhibits reduced downtime and maintenance requirements and/or high measurement reliability, accuracy, and sensitivity and/or low equipment requirements.

### DESCRIPTION OF THE INVENTION

According to the invention, embodiments include a measuring device for determining a constituent of a fluid sample, the measuring device comprising:
A) a flow assembly comprising:
   an inlet opening through which the fluid sample enters the flow assembly,
   an outlet opening through which the fluid sample exits the flow assembly,
   a flow element which guides the fluid sample from the inlet opening to the outlet opening,
   two or more fluid sensors for determining a physical and/or chemical measurement property of the fluid sample, wherein at least one of the two or more fluid sensors is an electrochemical sensor,
B) a dosing unit for dosing a calibration substance to the fluid sample.

The “measuring device” is a spatially bounded unit which comprises the flow assembly with the two or more fluid sensors and the dosing unit.

A flow assembly is a device designed to enable and adjust the directed flow of a medium (e.g., liquids, gases, or steam) within a preferably closed system. It may consist of one or more separate, interconnected components. The assembly comprises an inlet opening through which the fluid sample enters the flow assembly into the flow element, which in turn guides the fluid sample to the outlet opening through which the fluid sample exits the flow assembly. This thus forms a defined flow channel that allows targeted control of the flow of the fluid sample and monitoring of the properties of the fluid sample. For this purpose, the assembly typically includes additional components such as mounts for sensors or connections for samplers, enabling measurements, analyses, or sampling to be performed directly within the flow element. According to the invention, the flow assembly comprises two or more fluid sensors for determining a physical and/or chemical measurement property of the fluid sample. Possible sensors include amperometric sensors, redox potential sensors, pH sensors, conductivity sensors, temperature sensors, or flow sensors.

The measuring device further comprises a dosing unit for dosing a calibration substance to the fluid sample, i.e., a chemical compound with precisely known and documented properties that can be used to calibrate the measuring device. A dosing unit is a technical device or assembly designed to precisely supply or dispense a defined amount of a substance (e.g., liquid, gas, powder). In the simplest case, this could be a syringe; however, more complex dosing units with dosing containers and measurement and control technology are also possible. Dosing is carried out in accordance with specified parameters such as volume, mass, concentration, or time intervals in order to meet specific requirements in a process or system.

Preferably, the measuring device according to the invention is intended for determining an oxidizing agent, preferably bound and/or free chlorine. Free chlorine in a water sample refers to the amount of chlorine present in a reactive form, which can act as a disinfectant. It consists of two main components:
Hypochlorous acid (HOCl): An active form of free chlorine that acts as a strong oxidizing and disinfecting agent and is present at moderate pH values.
Hypochlorite ions (OCl⁻) : A less effective form, which becomes more predominant at higher pH values.

For the determination of free chlorine, the measuring device typically comprises an amperometric or redox potential sensor in combination with one or more additional sensors.

The term “for determining a constituent of a fluid sample” encompasses all types of qualitative and quantitative detection of the constituent contained in a sample. This includes, but is not limited to:
1. Qualitative determination: Establishing the presence or absence of a substance (also referred to as a constituent) in a sample.
2. Quantitative determination: Measuring or estimating the concentration or amount of a substance in a sample.
3. Semi-quantitative determination: Partial quantitative detection that allows a rough estimation of the concentration.

Preferably, the measuring device is used for the quantitative determination of a constituent.

By means of the inventive combined evaluation of the measurement signals from multiple sensors, temporally dynamic changes of the measuring device and external influences during measurement can be taken into account. This significantly increases the measurement accuracy and reliability of the measuring device. On the one hand, the undesired presence of oxidizing agents is reliably detected in this way. On the other hand, false alarms are reduced or even completely eliminated.

In the evaluation of the measurement signal of such a measuring device for trace detection, a static threshold value was often used in the past. However, this does not take into account the dynamic nature of the zero point signals of the sensors. The inventors discovered that the zero points can be influenced not only by external factors, but also by aging and/or deposit effects, for example. One possible countermeasure is the use of cleaning and calibration procedures known from the prior art. In addition, there is a dependence on other dissolved substances in the measurement medium. With the inventive method, which may use and combine detection criteria with dynamic threshold values in addition to static criteria, deviations of the zero points due to aging processes or external effects can be taken into account. This enables reliable trace detection of oxidizing agents such as chlorine in a range of <50 ppb, preferably <10 ppb, on a permanent basis without having to rely on manual cleaning procedures.

Preferably, at least one of the sensors, more preferably two or more of the two or more fluid sensors, is an electrochemical sensor selected from the group consisting of redox potential sensors, conductivity sensors, amperometric sensors, potentiometric sensors, and pH sensors.

Sensors operating according to electrochemical measurement principles are often used to determine the concentration of specific chemical substances. Therefore, at least one such sensor is typically employed to obtain an initial measurement value for the presence of the constituent or its concentration. This is usually an amperometric sensor or a redox potential sensor. According to the invention, such a sensor is preferably combined with an additional sensor for measuring the presence or concentration of the constituent (e.g., a second sensor selected from the group consisting of amperometric and redox potential sensors) and/or with one or more sensors for determining an external influence, such as a pH sensor, temperature sensor, conductivity sensor, or flow sensor.

For the specific case of determining free chlorine, amperometric sensors are typically used. They measure the current generated by a redox reaction involving chlorine at an electrode. The measured current is directly proportional to the concentration of dissolved chlorine. Such sensors generally offer high measurement accuracy; however, the measurement system is very easily affected by external factors. Therefore, for the determination of free chlorine, according to the invention, such an amperometric sensor is preferably combined with one or more sensors selected from the group consisting of pH sensors, flow sensors, temperature sensors, conductivity sensors, and redox potential sensors.

Preferably, at least one of the sensors, more preferably two or more of the two or more fluid sensors, is selected from the group consisting of flow sensors, such as Coriolis mass sensors, turbine flow sensors, ultrasonic flow sensors, reed switches with float elements, thermal flow sensors, or magnetic-inductive sensors; pressure sensors, such as piezoelectric sensors; conductivity sensors, such as conductive or inductive sensors; and temperature sensors, such as thermistors or thermocouples.

Open sensors come into direct contact with the medium to be measured. As a rule, they do not have any protective cover or housing that separates the measuring electrode(s) from the medium. The direct contact results in fast response times, high accuracy, and a simple, cost-effective design of the fluid sensor. In a preferred embodiment of the invention, at least one of the fluid sensors is therefore an open sensor.

In another preferred embodiment, one of the two or more fluid sensors comprises a measuring chamber sealed with a selectively permeable membrane. Through indirect contact with the sample medium, the measuring electrodes are protected from chemical, mechanical, and thermal influences, thereby reducing maintenance effort and failure rate.

Preferably, the flow element of the measuring device comprises a mixing module in which the dosing of the calibration substance to the fluid sample and its mixing with the sample take place. For this purpose, the measuring device may include a connecting element that links the dosing unit and the mixing module. Alternatively, the dosing unit may be integrated directly into the fluid stream in the flow element upstream of the mixing module. The dosing unit preferably comprises a dosing container in which a calibration solution can be kept available. The dosing container is preferably placed in a dedicated holder and connected via a quick hose coupling to a pump, such as a peristaltic pump, which injects the calibration solution into the fluid sample stream. Particularly preferably, the injection into the fluid sample stream is carried out via a lip valve, which is arranged below the mixing module.

A comparison of the calibration substance concentration measured in the fluid sample stream can be performed using a suitable reference method (e.g., DPD-1). The DPD-1 reference method is a chemical procedure for determining the free chlorine content in water. DPD stands for N,N-diethyl-p-phenylenediamine, a substance that reacts with free chlorine (e.g., hypochlorous acid and hypochlorite ions) to produce a pink to red coloration. The intensity of the color is proportional to the concentration of free chlorine and can be measured photometrically.

Preferably, the mixing module is arranged along the volume flow of the fluid sample from the inlet opening to the outlet opening in front of at least one, preferably in front of two or even all of the two or more fluid sensors. This spatially separates the mixing and measuring operations. As a result, homogeneous mixing of the calibration solution and fluid sample is ensured, which leads to stable measurement values.

In a preferred embodiment, the measuring device comprises an evaluation unit. The evaluation unit receives and processes the electrically measurable signals from the fluid sensors. These raw data correlate with the physical and/or chemical measurement properties to be determined. From these measured raw data, the evaluation unit can derive corresponding physical and/or chemical properties (e.g., temperature, pressure, conductivity, concentration, pH value) and, preferably in response to the determined values, provide feedback to other devices, for example to adjust process parameters or to trigger an alarm.

Preferably, the evaluation of the measurement properties is carried out using a deterministic detection algorithm that operates according to the principle of sensor data fusion. All measurement values from the two or more fluid sensors are thus combined and considered simultaneously. For this purpose, each measurement property is evaluated as part of a so-called indicator. Each indicator, in turn, consists of a variable number of criteria that define its state and are each designed either dynamically or statically. They utilize static or dynamic threshold values. A threshold value is static if it is defined by a fixed value. A threshold value is dynamic if it is derived from previous measurement values. When a threshold value is exceeded or not reached, the state of a criterion changes. A statement regarding the concentration of the constituent is obtained through the combined evaluation of the indicator states. Dynamic threshold values are preferably used, allowing the drifts of individual sensors to be taken into account and also considering the temporal behavior of the measurement signals. Particularly preferably, the detection algorithm comprises both static and dynamic criteria, and depending on the operating phase, the detection algorithm may be defined entirely by static or dynamic criteria or by a combination thereof, i.e., the threshold values used by the indicators may be all static, all dynamic, or a combination, depending on the operating phase.

However, neural networks and machine learning can also be employed for processing the measurement signals. These systems operate adaptively and are particularly suited to identifying patterns in large, complex data sets.

Preferably, the measuring device is configured and designed to enable both calibration and control of the dosing unit for dosing the calibration substance to the fluid sample. The acquisition and evaluation of the measurement signals for calibration, as well as the control of the dosing unit, are preferably combined within the evaluation unit and, particularly preferably, implemented so that this can be carried out simultaneously.

In a preferred embodiment, the constituent to be determined in the sample is an oxidizing agent, such as oxidatively acting halogen compounds of chlorine, bromine and iodine, chloramines and bromamines, Cl₂, Br₂, O₃, ClO₂, peracetic acid, H₂O₂, a hypochlorite salt or hypochlorous acid (HOCl), or Cl₂.

The invention also relates to a method for determining a constituent of a fluid sample using a measuring device as defined above and in the claims, comprising the following steps:
a) Providing a fluid sample in the flow assembly,
b) Determining a first physical and/or chemical measurement property of the fluid sample using one of the two or more fluid sensors.

Preferably, the fluid sample is supplied at least partially, and preferably completely, through the inlet opening of the flow assembly, thereby providing the fluid sample in the flow assembly. The fluid sample may, for example, be a portion of fluid diverted from the main fluid line (“bypass”). Such a method, and the associated bypass assembly, is typically used to integrate sensors, measuring devices, filters, or other components into the system without affecting the main fluid flow.

After supplying the fluid sample, the determination of a first measurement property of the fluid sample, which may be a physical and/or chemical measurement property, is carried out using the two or more fluid sensors.

The fluid sensors can operate together in determining a measurement property; for example, conductive or inductive sensors may be used for determining conductivity. Preferably, however, two or more different physical and/or chemical measurement properties are determined by the two or more sensors in order to derive the concentration of the constituent of the fluid sample.

After determining the first physical and/or chemical measurement property of the fluid sample using one of the two or more fluid sensors, the fluid sample preferably exits the flow assembly through the outlet opening.

Preferably, the “determination of a constituent” refers to the quantitative determination of a constituent. Quantitative determination in a sample is an analytical procedure aimed at measuring the exact quantity or concentration of a particular substance or compound within a sample. The goal is to obtain numerical values that can be specified in either absolute units (e.g., grams, millimoles) or relative units (e.g., percent, ppm). Preferably, the measuring device therefore comprises an evaluation unit configured to receive and process the physical and/or chemical measurement properties determined by the two or more fluid sensors, preferably using the deterministic detection algorithm described above, and the method comprises the following additional step:
c) Receiving and processing the physical and/or chemical measurement properties determined by the two or more fluid sensors and determining the concentration of the constituent in the fluid sample.

In a preferred embodiment of the inventive method, the concentration value determined in step c) is compared with a predefined threshold value. In this way, the evaluation unit can inform the user whether the concentration of the constituent to be determined is above or below the predefined threshold value.

By using two or more fluid sensors, several physical and/or chemical measurement properties can also be determined, thereby allowing for more precise determination of the concentration. For example, influences such as pressure or pH value may affect the concentration determination. By determining multiple physical and/or chemical measurement properties, these effects can be taken into account. The use of several physical and/or chemical measurement properties also permits active adjustment of the threshold values in the inventive method.

For example, if the sample contains an oxidizing agent that has a negative impact on the downstream application, temperature becomes an important factor in assessing the threshold value for the concentration of the oxidizing agent. If the sample has a higher temperature, the user can therefore require a lower threshold value for the constituent to be determined. The ability to make appropriate adjustments allows these influencing factors to be taken into account.

To verify the function of the measuring device and its calibration, the inventive method comprises the following step:
f) Dosing of a calibration substance to the fluid sample.

The dosing in step f) can be carried out in different temporal manners, depending on the requirements of the process, the properties of the substances, and the technical devices used. Preferably, the dosing of the calibration substance to the fluid sample takes place when the sample is in the flow assembly, and more preferably, the dosing takes place in a mixing module.

Subsequently, the detection of a physical and/or chemical measurement property by the two or more fluid sensors can then follow, thereby enabling calibration.

In principle, various process variants can be described that define the timing of the dosing of the calibration substance.

### Continuous Dosing

In continuous dosing, the calibration substance is added evenly over a certain period of time. In this case, the dosing amount is determined either by a constant flow rate or by proportional control. This method is particularly suitable when a continuous production process is involved or when chemical reactions are intended to proceed uniformly. Typically, pumps such as peristaltic or piston pumps are used to precisely control the dosing flow. Continuous dosing offers the advantage of uniform mixing and minimal fluctuations in the composition of the final solution.

### Discontinuous Dosing

In contrast, with discontinuous dosing, the calibration substance is added in clearly defined portions. This method can be performed either manually or automatically. Discontinuous addition allows each step to be monitored individually and adjusted if necessary.

### Pulsed Dosing

Another temporal pattern is pulsed dosing, in which the substance is dosed in short, rapid intervals. The interval may range from minutes up to a maximum of 24 hours. Technically, this is often achieved by means of solenoid valves or fast-switching pumps.

### Intermittent Dosing

Another temporal pattern is intermittent dosing, in which the substance is added at large time intervals, >1 week up to 12 months. Generally, intermittent dosing of the calibration substance is sufficient.

### Variable Dosing

Finally, variable dosing is also possible, in which the flow rate of the substance is adjusted during the calibration process. Variable dosing typically requires precise control by software or control circuits that take real-time data such as pH value, temperature, or concentration into account.

The invention also relates to a measuring device according to the invention with a fluid sample arranged in the flow assembly. The fluid sample may, for example, be an aqueous sample.

The invention further relates to the use of the measuring device in water treatment, in particular for the protection of reverse osmosis systems or in disinfection.

According to a further aspect, the invention also relates to a measuring device for determining a constituent of a fluid sample, the measuring device comprising:
A) a flow assembly comprising:
   an inlet opening through which the fluid sample enters the flow assembly,
   an outlet opening through which the fluid sample exits the flow assembly,
   a flow element which guides the fluid sample from the inlet opening to the outlet opening,
   two or more fluid sensors for determining a physical and/or chemical measurement property of the fluid sample, wherein at least one of the two or more fluid sensors is an electrochemical sensor, and
C) an evaluation unit configured to receive and process the physical and/or chemical measurement property determined by the two or more fluid sensors.

The measuring device according to this aspect may also comprise the further features defined in original claims 1-7 and 8-10 as well as in the preceding description text, in particular B) a dosing unit for dosing a calibration substance to the fluid sample.

The attached figure represents a specific embodiment of the invention and shows:

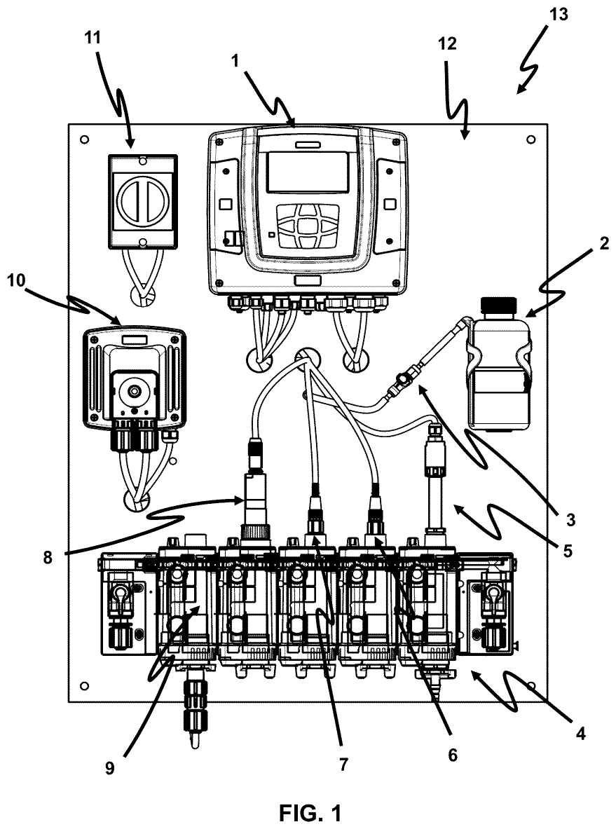

FIG. 1: Schematic representation of a specific embodiment of a measuring device according to the invention with a total of four fluid sensors.

FIG. 1 shows a schematic representation of a plate-mounted measuring device 13, which is used for monitoring the absence of free chlorine. For measurement, the measurement signals from four sensors (free chlorine, pH, redox, and flow) are combined and received and processed in an evaluation unit 1. The evaluation of the measurement signals is performed by a detection algorithm that operates according to the principle of sensor data fusion. Thus, all individual signals are combined and considered simultaneously. In the case shown, the function of the system can be verified by dosing a calibration solution. This dosing also serves to calibrate the chlorine sensor.

The components of the measuring device 13 are mounted on a base plate. The sensors are integrated into the bypass assembly 4. The bypass assembly 4 comprises several sections, also referred to as modules. The first module is formed by the mixing module 9, which is used for dosing the calibration solution. This is followed by modules comprising an open chlorine sensor for measuring free chlorine concentration 8, a pH sensor 7, a redox sensor 6, and a reed switch for flow monitoring 5. The flow through the assembly is monitored at the lower end by the reed switch and can, if necessary, be limited at the upper end by a flow restrictor.

The flow passes through the bypass assembly 4 from a first inlet opening, which is arranged on the left side in front of the mixing module 9, through the modules with the respective sensors 8-5 to a first outlet opening arranged on the right edge of the bypass assembly 4.

The measuring device 13 further comprises a dosing unit for dosing a calibration solution. This solution is prepared from a calibration reagent and made available in the dosing container 2 for dosing into the mixing module 9. The dosing container 2 is placed in the holder and is hydraulically connected to the peristaltic pump 10 via a quick hose coupling 3. The injection of the calibration solution into the process stream takes place via the lip valve, which is mounted below the mixing module 9 of the bypass assembly 4.

The sensors 8-5 are connected to the evaluation unit 1, which receives and evaluates the measurement properties determined there. The measurement properties are read and processed by the evaluation unit either continuously or at recurring intervals. Preferably, measurement is interrupted during calibration.

### Reference Numerals

1 evaluation unit
2 dosing container
3 quick hose coupling
4 bypass assembly
5 reed switch for flow monitoring
6 redox potential sensor
7 pH sensor
8 open chlorine sensor/chlorine concentration
9 mixing module
10 peristaltic pump
11 main switch
12 base plate
13 measuring device

1. A measuring device for determining a constituent of a fluid sample, the measuring device comprising:
A) a flow assembly comprising:
an inlet opening through which the fluid sample enters the flow assembly,
an outlet opening through which the fluid sample exits the flow assembly,
a flow element which guides the fluid sample from the inlet opening to the outlet opening,
two or more fluid sensors for determining a physical and/or chemical measurement property of the fluid sample, wherein at least one of the two or more fluid sensors is an electrochemical sensor; and
B) a dosing unit for dosing a calibration substance to the fluid sample.

2. The measuring device according to claim 1, wherein at least one of the two or more fluid sensors is an electrochemical sensor selected from the group consisting of
redox potential sensors,
amperometric sensors, and
pH sensors.

3. The measuring device according to claim 1, wherein at least one of the two or more fluid sensors is selected from the group consisting of
flow sensors,
conductivity sensors,
temperature sensors.

4. The measuring device according to claim 1, wherein at least one of the two or more fluid sensors comprises a measuring chamber sealed with a selectively permeable membrane.

5. The measuring device according to claim 1, wherein the flow element comprises a mixing module in which the dosing of the calibration substance to the fluid sample and its mixing with the sample takes place.

6. The measuring device according to claim 5, wherein the mixing module is arranged along the volume flow of the fluid sample from the inlet opening to the outlet opening in front of at least one of the two or more fluid sensors.

7. The measuring device according to claim 1, wherein the dosing unit comprises a pump, optionally a peristaltic pump, for dosing the calibration substance to the fluid sample.

8. The measuring device according to claim 1, further comprising
C) an evaluation unit configured to receive and process the physical and/or chemical measurement property determined by the two or more fluid sensors.

9. The measuring device according to claim 8, wherein the measuring device is configured to enable time-alternating and/or simultaneous calibration and control of the dosing unit.

10. The measuring device according to claim 1, wherein the constituent to be determined is an oxidizing agent, optionally oxidatively acting halogen compounds of chlorine, bromine and iodine, chloramines and bromamines, Cl₂, Br₂, O₃, ClO₂, peracetic acid, H₂O₂, a hypochlorite salt, or hypochlorous acid (HOCl).

11. A method for determining a constituent of a fluid sample using a measuring device according to claim 1 comprising the following steps:
a) providing a fluid sample in the flow assembly, and
b) determining a first physical and/or chemical measurement property of the fluid
sample using one of the two or more fluid sensors,

12. The method according to claim 11, wherein the measuring device further comprises an evaluation unit configured to receive and process the physical and/or chemical measurement property determined by the two or more fluid sensors, and wherein the method further comprises the following step:
c) receiving and processing of the physical and/or chemical measurement property determined by the two or more fluid sensors and determining the concentration of the constituent of the fluid sample.

13. The method according to claim 12, wherein the method further comprises the following step:
d) comparing the concentration determined in step c) with a predefined threshold value.

14. The method according to claim 11, wherein the method further comprises the following step:
e) determining a second physical and/or chemical measurement property of the sample using one of the two or more fluid sensors and adapting the threshold value.

15. The method according to claim 11, wherein the method further comprises the following step:
f) continuous or pulsed or intermittent dosing of a calibration substance to the fluid sample.
